(19) United States
(12) Patent Application Publication
(10) Pub. No.: US 2009/0057409 A1
(43) Pub. Date: Mar. 5, 2009

(54) Automatic raster height and speed adjustment in programmable electeo-optical readers for reading two-dimensional symbols of different heights

(76) Inventors: Nina Feinstein, Hicksville, NY (US); Mark Anderson, Dix Hills, NY (US)

Correspondence Address: Kirschstein, Ottinger, Israel & Schiffmiller, P.C., 425 Fifth Avenue, New York, NY, 10016, US

(21) Appl. No.: 11/897,486

(22) Filed: Aug. 30, 2007

(51) Int. Cl. G06K 7/10

(52) U.S. Cl. 235/462.02

(57) ABSTRACT

A reader for electro-optically reading two-dimensional symbols of different heights, includes a scanner for scanning the symbols with light in a raster scan pattern of an adjustable height, and for detecting light scattered from the symbols to generate electrical signals indicative of the detected light. A controller not only decodes the electrical signals to read the symbols, but also controls the scanner to adjust the height of the raster scan pattern, and optionally the rate of height adjustment, upon a determination that a symbol being scanned is a two-dimensional symbol, and that the two-dimensional symbol has not been read after a predetermined time period has elapsed. The controller can also be programmed to read symbols only of a certain height.

### BACKGROUND OF THE INVENTION

A bar code symbol is a coded pattern of indicia having a series of variable-width bars separated by variable-width spaces, the bars and spaces having different light-reflecting characteristics. One example of a one-dimensional symbol is the UPC/EAN code currently in use for identifying articles. One example of a two-dimensional, or stacked, symbol is the PDF-417 symbol described in U.S. Pat. No. 5,159,639, which is incorporated herein by reference. Other examples of two-dimensional symbols are micro-PDF symbols of smaller capacity and height than the PDF-417 symbols and composite symbols, each comprised of a one-dimensional symbol component and a two-dimensional symbol component.

A moving beam electro-optical reader sweeps a beam of light in a scan pattern across a symbol. The scan pattern may be a single line or a series of scan lines arranged in a raster pattern. A photodetector detects light scattered from the symbol and generates an electrical signal indicative of the intensity of the detected light. The electrical signal is digitized and decoded to extract information encoded in the symbol. Scanning systems of this general type are described in U.S. Pat. No. 4,251,798; No. 4,360,798; No. 4,369,361; No. 4,387,297; No. 4,409,470; and No. 4,460,120.

To read a two-dimensional symbol, the raster scan pattern has to be large enough to cover the entire area of the symbol, that is, all the rows thereof. Otherwise, an operator holding a handheld reader that generates a small raster scan pattern would have to physically move the reader up and down to insure that the raster scan pattern fully covers the symbol.

Some conventional readers generate large scan patterns that cover not only the two-dimensional symbol, but also overscan areas outside of the two-dimensional symbol. Although using such a large scan pattern does not affect the accuracy of the reader, it is inefficient. The overscan areas of the scan pattern which lay outside the symbol are useless, and scanning these overscan areas slows down the reading operation. In addition, forcing the scan pattern to be too large reduces the accuracy of decoding the two-dimensional symbol.

Another concern involving two-dimensional symbols is that they do not all have the same height. Thus, a micro-PDF symbol typically has a smaller height than a PDF-417 symbol or a composite symbol. A raster pattern of a single height may be too large for one type of two-dimensional symbol, thereby resulting in the inefficient and slow reading described above, and too small for another type of two-dimensional symbol, thereby resulting in the physical reader movement described above.

It is also known in the art to dynamically adjust the height of the raster pattern upon a determination whether a symbol being read is one- or two-dimensional. Thus, as described in U.S. Pat. No. 5,235,167; No. 5,561,283; and No. 5,600,119, an initial shorter height can be used for aiming at symbols or for reading a one-dimensional symbol, while a final taller height can be used for reading a two-dimensional symbol. As advantageous as such height adjustment is, much time and processing power are spent in determining whether a sensed target is a bar code symbol or not and, if so, whether that symbol is a one-dimensional or a two-dimensional symbol.

### SUMMARY OF INVENTION

One feature of the present invention resides in a reader for, and a method of, electro-optically reading two-dimensional symbols having different heights. The reader includes a scanner for scanning the symbols with light in a raster scan pattern of an adjustable height, and for detecting light scattered from the symbols to generate electrical signals indicative of the detected light. The reader further includes a controller for decoding the electrical signals to read the symbols.

In accordance with one aspect of this invention, the controller is operative for controlling the scanner to adjust the height of the raster scan pattern upon a determination that a symbol being scanned is a two-dimensional symbol, and that the two-dimensional symbol has not been read after a predetermined time period has elapsed. Only two-dimensional symbols are read, and the adjustment in the height of the raster pattern is performed in real time automatically after a determination has been made that the two-dimensional symbol has not been read.

In a preferred embodiment, the scanner includes a light source, e.g., a laser diode, for generating a light beam, and a movable scanning component, e.g., a pair of scan mirrors oscillated along mutually orthogonal directions by a drive, for moving the light beam along scan lines that form the raster scan pattern. The scanner also includes a light detector, e.g., a photodiode, for detecting the light scattered from the symbols to generate the electrical signals as analog signals, and a digitizer for digitizing the analog signals to produce digitized signals. The controller is operative for decoding the digitized signals.

The controller is also operative for controlling the scanner to adjust the height of the raster scan pattern to have an initial predetermined small value corresponding to a short height for the raster scan pattern, and to have a final predetermined large value corresponding to a tall height for the raster scan pattern. The predetermined time period is preferably a fraction of a second.

In accordance with another aspect of this invention, the controller is operative for controlling the scanner to adjust a rate at which the height of the raster scan pattern is adjusted. Preferably, the rate is slowed upon the determination that the two-dimensional symbol being scanned has not been read after the predetermined time period has elapsed. By slowing this rate, the likelihood that each row of a two-dimensional symbol will be read is increased. The rate adjustment is preferably performed simultaneously with the height adjustment.

In accordance with yet another aspect of this invention, the controller is programmable for controlling the scanner to adjust the height of the raster scan pattern to be a single height to read symbols only of that single height. The controller is programmed by operating the reader to read a unique programming symbol that programs the controller, or the controller may also be programmed by an electronic configuration. This improves the performance of the reader by tailoring the raster scan height to the height of the type of two-dimensional symbols being read for a particular application.

The method of electro-optically reading two-dimensional symbols having different heights in accordance with still another aspect of this invention includes the steps of scanning the symbols with light in a raster scan pattern of an adjustable height, detecting light scattered from the symbols to generate electrical signals indicative of the detected light, decoding the electrical signals to read the symbols, and adjusting the height of the raster scan pattern upon a determination that a symbol being scanned is a two-dimensional symbol, and that the two-dimensional symbol has not been read after a predetermined time period has elapsed.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF DRAWINGS

FIG. 1 is a simplified diagrammatic representation of one embodiment of an electro-optical reader according to this invention;

FIG. 2 is a diagram of a conventional raster scan pattern according to the prior art;

FIGS. 3a, 3b and 3c are representations of two-dimensional symbols of different heights to be read by the reader of FIG. 1; and

FIG. 4 is a flow chart of a preferred procedure for adjusting raster scan pattern height and adjustment rate according to this invention.

### DETAILED DESCRIPTION OF THE PREFERRED EMBODIMENTS

Unless the context or specific instructions indicate otherwise, the terms “symbol” and “bar code” should be construed broadly in this specification and the following claims. For example, those terms cover any number of patterns having alternating bars and spaces, including those of various widths, and two-dimensional graphic patterns other than those specifically mentioned.

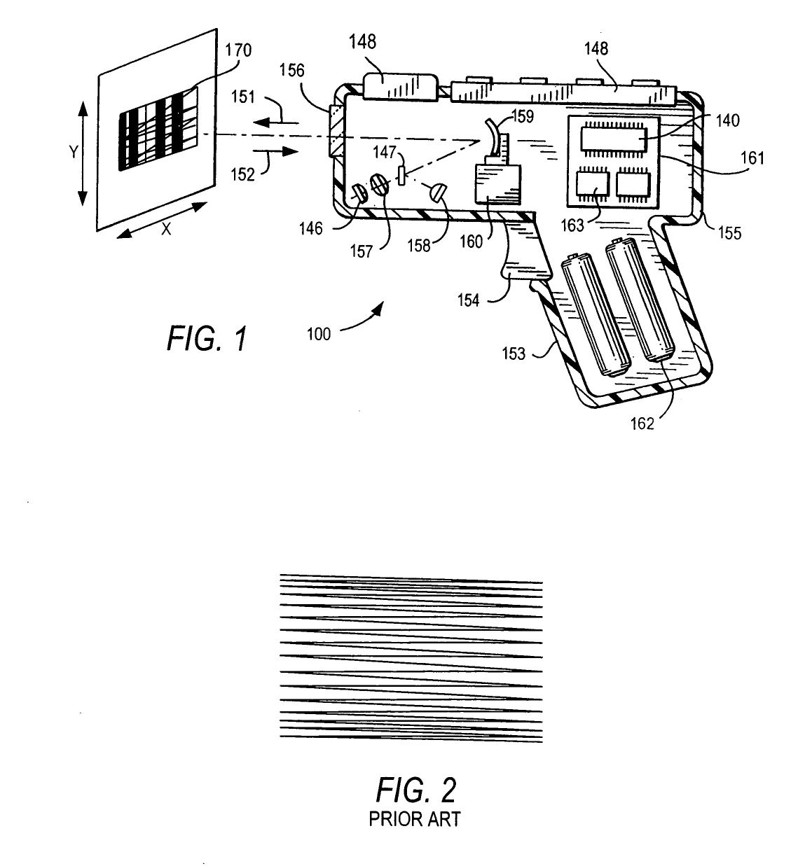

FIG. 1 shows a highly simplified embodiment of a bar code symbol reader 100 that may be constructed according to the principles of the present invention. Although FIG. 1 shows reader 100 as hand-held, the invention does not require that the reader be in this form. For example, the reader could include a desktop workstation or have some other type of stationary architecture. Reader 100 may also function as a portable computer terminal and include a keyboard 148 and a display 149, such as described in U.S. Pat. No. 4,409,470.

A user aims the reader at a two-dimensional bar code symbol 170 without physically touching it. Typically, reader 100 operates several inches from the symbol being read. Reader 100 is preferably gun-shaped in a housing 155 having a pistol-grip handle 153. A movable trigger 154 on the handle 153 allows the user to activate a light beam 151 when the user has pointed reader 100 at the symbol 170.

Housing 155, which is preferably made of lightweight plastic, contains a laser light source 146 (which may be a semiconductor laser diode or other light source), a focusing lens 157, a partially-silvered mirror 147, a light detector 158, an oscillating scan mirror 159, a drive motor 160, a power source (battery) 162, and a signal processing and control circuitry that includes a microprocessor or controller 140 on a printed circuit board 161.

When the user activates the reader 100 by pulling trigger 154, the light source 146 generates the light beam 151 along an optical axis of the lens 157. Lens 157 may be a single lens or a multiple lens system. After passing through the lens 157, the beam 151 passes through the partially-silvered mirror 147 and, if desired, other lenses, or beam-shaping structures. Beam 151 then strikes the oscillating scan mirror 159 driven by the scanning motor 160, which together direct the beam 151 through a light-transmissive window 156 in a scan pattern across the symbol 170. Preferably, the motor 160 also starts when the user pulls the trigger 154.

FIG. 2 is a diagram depicting a two-dimensional raster scan pattern that can be generated by displacing the light beam 151 in the vertical or y-direction and in the horizontal or x-direction. U.S. Pat. No. 4,387,297 explains a technique for forming the raster scan pattern of FIG. 2. The x-direction extends along the width of the symbol, i.e., lengthwise along each row. The y-direction extends along the height of the symbol, i.e., generally perpendicular to each row.

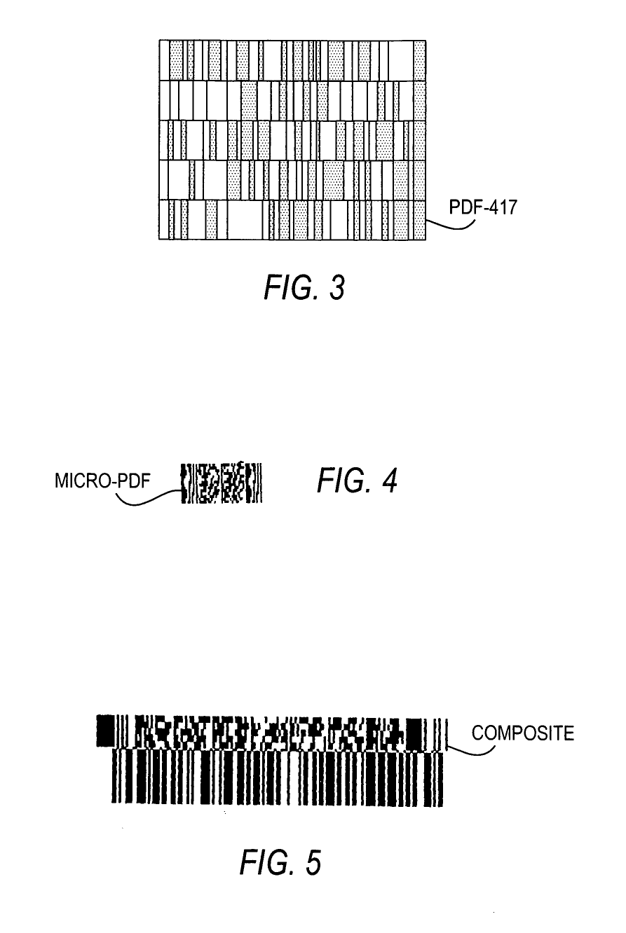

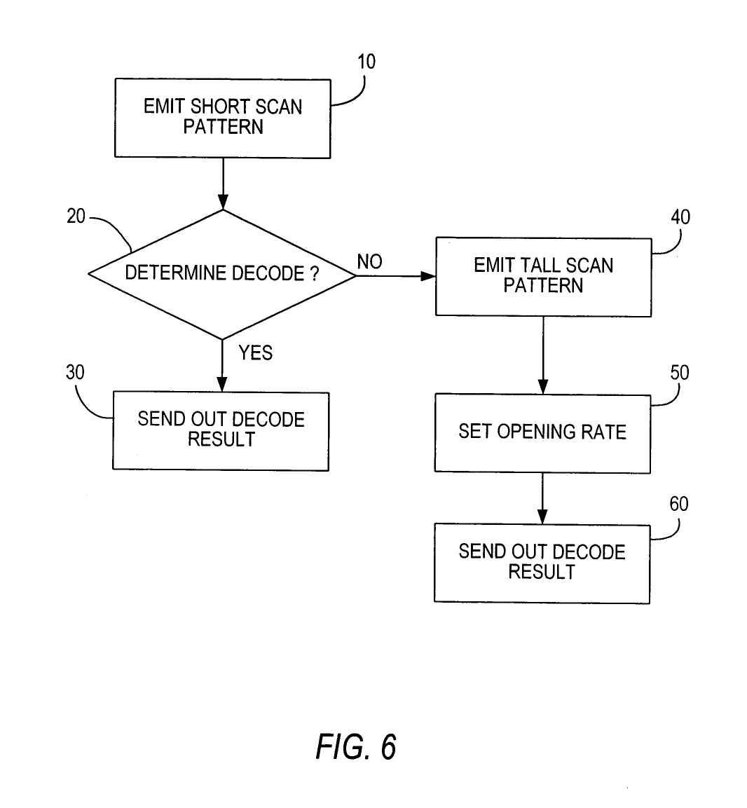

Symbol 170 can be a two-dimensional bar code, such as PDF-417, as shown in FIG. 3 and as described in U.S. Pat. No. 5,159,639. In addition, symbol 170 can be a micro-PDF bar code, as shown in FIG. 4. The micro-PDF bar code is smaller in height and capacity and, hence, is more space efficient than the PDF-417 code. The micro-PDF bar code is typically used for small product marking such as electronic components, auto parts, test tubes, etc.

Symbol 170 can also be a composite bar code, as shown in FIG. 5. The composite code has a one-dimensional (linear) component and a two-dimensional component. There are three types of composite codes: CC-A, CC-B and CC-C. CC-A is a variant of micro-PDF linked with a one-dimensional symbol, the two-dimensional symbol encoding up to 56 characters. CC-B is a micro-PDF symbol linked with a one-dimensional symbol, the two-dimensional symbol encoding up to 338 characters. CC-C is a PDF-417 symbol linked with a one-dimensional symbol, the two-dimensional symbol encoding up to 2,361 characters. The linear component can be UCC/EAN128, EAN13, EAN8, UPCA, UPCE, or a GS1 DataBar(RSS) variant. The composite code is typically used for logistics and transportation applications, healthcare and non-retail, small-item applications. All of these codes have different heights.

The light 152 is a portion of the light beam 151 scattered off the symbol 170. Light 152 returns to reader 100 along a path parallel to, or at times coincident with, beam 151. Light 152 thus reflects off the scan mirror 159 and strikes the partially-silvered mirror 147. Mirror 147 reflects some of the light 152 onto a light-responsive detector 158, e.g., a photodiode, that converts the light 152 into electrical signals. The electrical signals are processed in the signal processing and control circuitry and decoded by the controller 140 to extract the information represented by the symbol. The controller 140 also controls the operation of the motor 160.

The reader 100 is used to read two-dimensional symbols which, as noted above, have different heights. A raster pattern of a single height may be too large for one type of two-dimensional symbol, and too small for another type of two-dimensional symbol. In accordance with one aspect of this invention, the controller 140 is operative for adjusting the height of the raster scan pattern upon a determination that a two-dimensional symbol has not been read after a predetermined time period, e.g., a fraction of a second, has elapsed. The adjustment is made by controlling the angle through which the scan mirror 159 is oscillated by the drive motor 160 along the y-direction. The adjustment in the height of the raster pattern is performed in real time automatically after the determination has been made that a two-dimensional symbol has not been read.

The controller adjusts the height of the raster scan pattern to have an initial predetermined small value corresponding to a short height for the raster scan pattern, and to have a final predetermined large value corresponding to a tall height for the raster scan pattern. For example, in a preferred embodiment, the scan angle through which the scan mirror 159 is oscillated by the drive motor 160 along the y-direction can be on the order of 4 degrees for the short height raster scan pattern, and on the order of 6 degrees for the tall height raster scan pattern.

More specifically, FIG. 6 depicts a flow chart indicating the preferred procedure for reading two-dimensional symbols of different heights. In the preferred embodiment, the user presses the trigger 154 to begin scanning. Pressing the trigger causes the reader 100 to produce a short, i.e., small vertical displacement, scan pattern (Step 10), and then the reader 100 attempts to decode the symbol without altering the height of the short scan pattern (Step 20). If the symbol being scanned is a two-dimensional symbol, and if the decode is successful, then the reader 100 sends the decoded data out for further processing (Step 30).

If the decode of the two-dimensional symbol is unsuccessful, then, after a predetermined time period, the reader 100 produces a tall, i.e., large vertical displacement, scan pattern (Step 40) and enters a full raster mode, which signifies the process of having the controller 140 control the motor 160 to change the height of the raster scanning pattern. During full raster mode, the pattern height may increase all at once, or in stages. The predetermined time period is preferably a fraction of a second, but may be up to three seconds.

In accordance with another aspect of this invention, the controller is operative for also adjusting a rate (Step 50) at which the height of the raster scan pattern is adjusted. Preferably, the rate is slowed upon the determination that the two-dimensional symbol has not been read after the predetermined time period has elapsed. By slowing this rate, the likelihood that each row of the two-dimensional symbol will be read is increased. If the decode is successful, then the reader 100 sends the decoded data out for further processing (Step 60). Steps 40 and 50 are preferably performed simultaneously, but could be performed separately.

In accordance with yet another aspect of this invention, the controller 140 is programmable for adjusting the height of the raster scan pattern to be a single height to read symbols only of that single height. The controller 140 is programmed by operating the reader 100 to read a unique programming symbol 170 that programs the controller. This programming symbol 170 is unique and different from all other symbols to be read. Indeed, the controller 140 is programmed to adjust the height of the raster scan pattern to be a single height only when this unique symbol 170 is read. This improves the performance of the reader by tailoring the raster scan height to the height of the type of two-dimensional symbols being read for a particular application. Preferably, this programming symbol 170 is a bar code symbol printed on a media sheet, which may be part of an operating manual for the reader. The controller 140 may also be programmed by an electronic configuration.

Once the reader 100 is aimed at the symbol, the reader 100 ensures that the symbol is a two-dimensional bar code symbol. There are several conventional techniques for making this determination. These techniques are not the exclusive methods of distinguishing bar code symbols, nor are they mutually exclusive, One or more techniques may be used together.

For example, one technique involves analyzing the spatial variation of the areas of different light reflectivity to determine whether the reflected light has characteristics expected from a two-dimensional bar code symbol. Signal processing and control circuitry would typically be programmed to perform this analysis. Another technique compares the electrical signals generated from one scan with that from one or more subsequent scans. If the successive scans differ, but have similar groupings, then the symbol is likely a two-dimensional bar code symbol.

It will be understood that each of the elements described above, or two or more together, also may find a useful application in other types of constructions differing from the types described above.

While the invention has been illustrated and described as embodied in an automatic raster height and speed adjustment in programmable electro-optical readers for, and method of, reading two-dimensional symbols of different heights, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims:

1. A reader for electro-optically reading two-dimensional symbols having different heights, comprising:
a scanner for scanning the symbols with light in a raster scan pattern of an adjustable height, and for detecting light scattered from the symbols to generate electrical signals indicative of the detected light; and
a controller for decoding the electrical signals to read the symbols, and for controlling the scanner to adjust the height of the raster scan pattern upon a determination that a symbol being scanned is a two-dimensional symbol, and that the two-dimensional symbol has not been read after a predetermined time period has elapsed.

2. The reader of claim 1, wherein the scanner includes a light source for generating a light beam, and a movable scanning component for moving the light beam along scan lines that form the raster scan pattern.

3. The reader of claim 1, wherein the scanner includes a light detector for detecting the light scattered from the symbols to generate the electrical signals as analog signals, and a digitizer for digitizing the analog signals to produce digitized signals; and wherein the controller is operative for decoding the digitized signals.

4. The reader of claim 1, wherein the controller is operative for controlling the scanner to adjust the height of the raster scan pattern to have an initial predetermined small value corresponding to a short height for the raster scan pattern, and to have a final predetermined large value corresponding to a tall height for the raster scan pattern.

5. The reader of claim 1, wherein the predetermined time period is a fraction of a second.

6. The reader of claim 1, wherein the controller is operative for controlling the scanner to adjust a rate at which the height of the raster scan pattern is adjusted.

7. The reader of claim 6, wherein the rate is slowed upon the determination that the two-dimensional symbol has not been read after the predetermined time period has elapsed.

8. The reader of claim 1, wherein the controller is programmable for controlling the scanner to adjust the height of the raster scan pattern to be a single height to read symbols only of that single height, and wherein the controller is programmed by operating the reader to read a unique programming symbol that programs the controller.

9. A reader for electro-optically reading two-dimensional symbols having different heights, comprising:
scanner means for scanning the symbols with light in a raster scan pattern of an adjustable height, and for detecting light scattered from the symbols to generate electrical signals indicative of the detected light; and
control means for decoding the electrical signals to read the symbols, and for controlling the scanner means to adjust the height of the raster scan pattern upon a determination that a symbol being scanned is a two-dimensional symbol, and that the two-dimensional symbol has not been read after a predetermined time period has elapsed.

10. The reader of claim 9, wherein the control means is operative for controlling the scanner means to adjust the height of the raster scan pattern to have an initial predetermined small value corresponding to a short height for the raster scan pattern, and to have a final predetermined large value corresponding to a tall height for the raster scan pattern.

11. The reader of claim 9, wherein the control means is operative for controlling the scanner means to adjust a rate at which the height of the raster scan pattern is adjusted.

12. The reader of claim 9, wherein the control means is programmable for controlling the scanner means to adjust the height of the raster scan pattern to be a single height to read symbols only of that single height, and wherein the control means is programmed by operating the reader to read a unique programming symbol that programs the control means.

13. A method of electro-optically reading two-dimensional symbols having different heights, comprising the steps of:
scanning the symbols with light in a raster scan pattern of an adjustable height;
detecting light scattered from the symbols to generate electrical signals indicative of the detected light;
decoding the electrical signals to read the symbols; and
adjusting the height of the raster scan pattern upon a determination that a symbol being scanned is a two-dimensional symbol, and that the two-dimensional symbol has not been read after a predetermined time period has elapsed.

14. The method of claim 13, and generating a light beam, and moving the light beam along scan lines that form the raster scan pattern.

15. The method of claim 13, wherein the detecting step is performed by detecting the light scattered from the symbols to generate the electrical signals as analog signals, and digitizing the analog signals to produce digitized signals; and wherein the decoding step is performed by decoding the digitized signals.

16. The method of claim 13, wherein the adjusting step is performed by adjusting the height of the raster scan pattern to have an initial predetermined small value corresponding to a short height for the raster scan pattern, and to have a final predetermined large value corresponding to a tall height for the raster scan pattern.

17. The method of claim 13, wherein the predetermined time period is a fraction of a second.

18. The method of claim 13, wherein the adjusting step is performed by adjusting a rate at which the height of the raster scan pattern is adjusted.

19. The method of claim 18, and slowing the rate upon the determination that the two-dimensional symbol has not been read after the predetermined time period has elapsed.

20. The method of claim 13, wherein the adjusting step is performed by adjusting the height of the raster scan pattern to be a single height to read symbols only of that single height by operating the reader to read a unique programming symbol.
